(19) United States
(12) Patent Application Publication
(10) Pub. No.: US 2009/0095227 A1
(43) Pub. Date: Apr. 16, 2009

(54) Farrowing Pen

(75) Inventor: Bernard Laake, Langen (DE)

Correspondence Address: HARNESS, DICKEY & PIERCE, P.L.C., P.O. BOX 828, BLOOMFIELD HILLS, MI, 48303, US

(73) Assignee: CTB, INC., Milford, IN (US)

(21) Appl. No.: 12/226,890

(22) PCT Filed: Apr. 28, 2007
(86) PCT No.: PCT/DE2007/000770

§ 371 Date: Oct. 31, 2008

(30) Foreign Application Priority Data
May 2, 2006 (DE) 20 2006 006 968.2

(51) Int. Cl. A01K 1/02

(52) U.S. Cl. 119/503; 119/515; 119/502

(57) ABSTRACT

The invention relates to a farrowing pen comprising an associated pigpen whose sidewalls form a feeding trough in the forward area. The sidewalls are connected to a wall either directly or via extensions while the farrowing pen is fixedly arranged on an associated prefabricated steel wall. One, two, or four respective farrowing pens can be connected to one prefabricated steel wall.

The invention relates to a farrowing pen with an assigned pigsty, the side walls of which in the front region form a feed trough, where the side walls are fastened to a wall directly or through extensions.

In general, pigsties with assigned farrowing pens are produced in solid construction, where the farrowing pens are mounted, preferably bolted, on the solid walls. If the walls are not made sufficiently sturdy, problems of support develop.

The object of the invention is to design farrowing pens with an assigned pigsty of the type indicated so that, even with lightweight walls and even without the presence of lightweight walls, a sturdy arrangement is assured.

According to the invention, this object is accomplished in that the farrowing pen is firmly mounted on an assigned steel mounting wall. In development of the invention, the steel mounting wall has lower rectangular offsets, which are capable of being bolted to the floor of the sty.

The steel mounting wall advantageously has the bores required for fastening of the farrowing pen. The lateral boundaries of the steel mounting wall may have angular offsets. The possibility exists of fastening two farrowing pens lying side-by-side to one steel mounting wall in each instance. In a preferred embodiment, each farrowing pen has brackets projecting over the side walls in the front region, the fastening of which runs parallel to the steel mounting wall. The possibility exists of mounting a limiting plate of synthetic material between two steel mounting walls mounted spaced apart. The limiting plate advantageously runs in a line with the adjacent steel mounting walls, the limiting plate being capable of insertion into the lateral angular offsets of the steel mounting walls.

Especially advantageously, the steel mounting wall may be assigned to a lightweight wall. Fastening of the steel mounting wall to the lightweight wall advantageously is effected by bolting. To increase sturdiness, in development of the invention a supporting wall is attached, preferably bolted on, centrally at right angles to the steel mounting wall.

According to the invention, the possibility exists of fastening four farrowing pens to one steel mounting wall, where on each side of the steel mounting wall two farrowing pens are fastened side-by-side in each instance. A central supporting wall advantageously is assigned to each side of the steel mounting wall.

Exemplary embodiments of the invention are shown in the drawing and are described below.

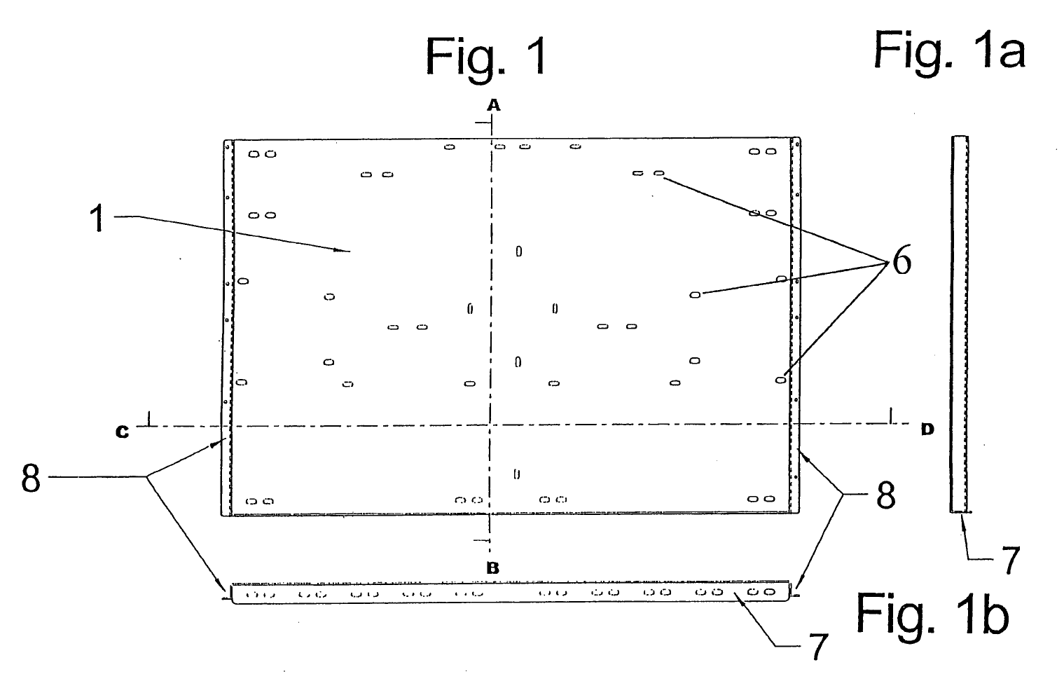

FIG. 1 shows a view of a steel mounting wall;

FIG. 1a, a section A-B of FIG. 1;

FIG. 1b, a section C-D of FIG. 1;

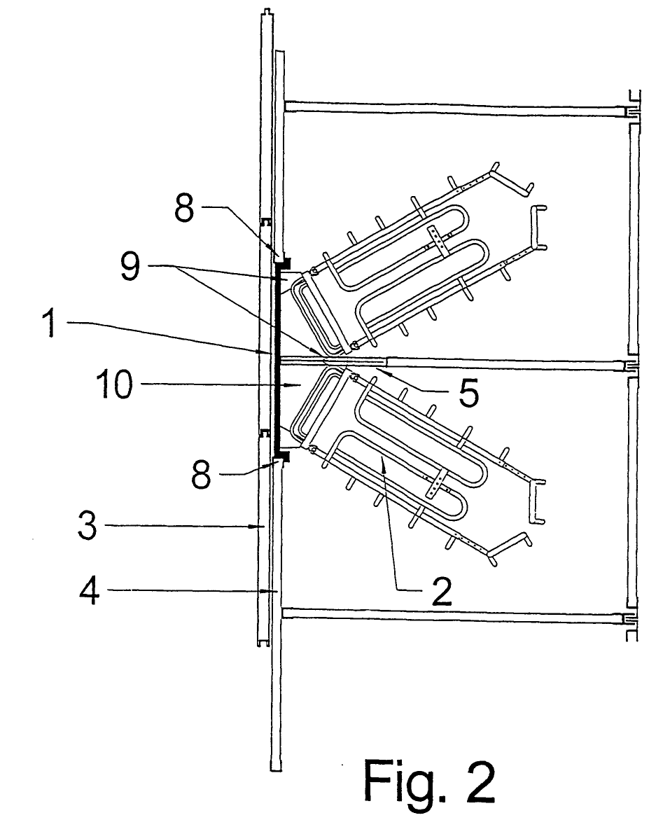

FIG. 2, a top view of two farrowing pens, each with an assigned sow cage, mounted on a lightweight wall;

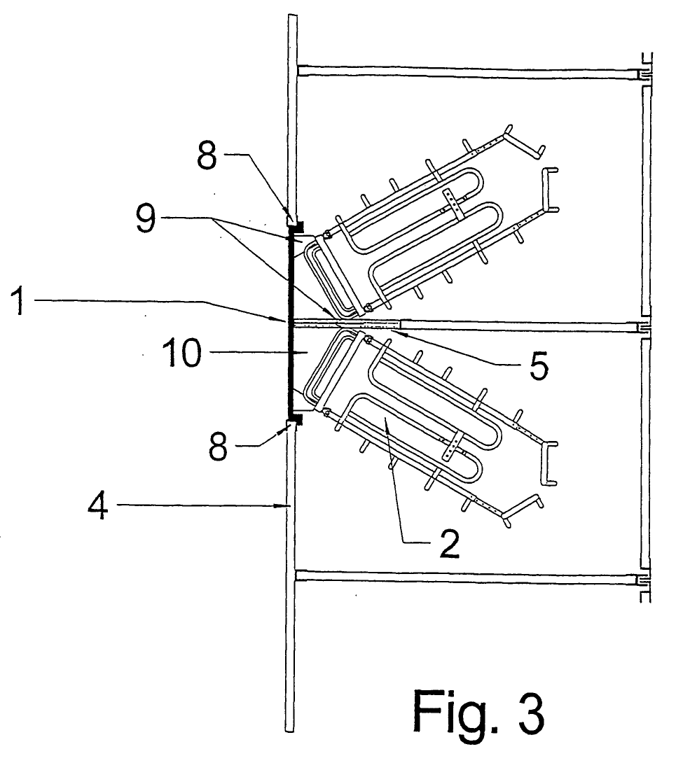

FIG. 3 like FIG. 2, but without lightweight wall and

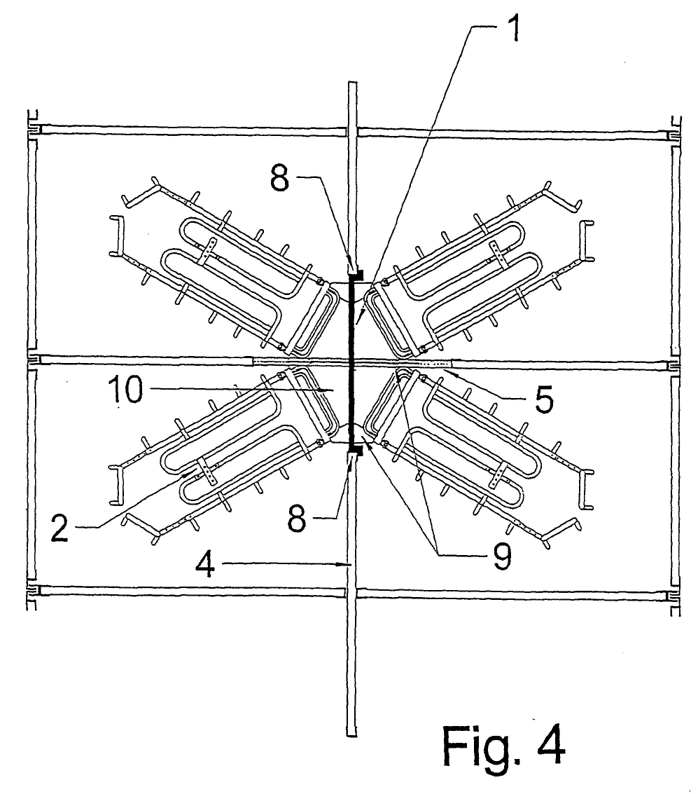

FIG. 4, a top view of four farrowing pens arranged facing pairwise.

The farrowing pens 2 shown in the figures are basically arranged in rows in each instance. The core of the invention is the steel mounting wall 1 shown in the figures, which has the bores 6 required for fastening of the farrowing pens 2. The steel mounting wall 1 has lower rectangular offsets 7, which are bolted to the floor of the sty. The farrowing pen 2 is firmly bolted to the steel mounting wall 1.

As FIG. 1b shows, the lateral boundaries of the steel mounting wall 1 have angular offsets 8, into which a limiting plate 4 is capable of insertion. Each farrowing pen 2 has in the front region brackets 9 projecting over the side walls, the fastening of which runs parallel to the steel mounting wall 1.

According to FIG. 2, two farrowing pens 2 lying side-by-side are fastened to a steel mounting wall 1. Between two mounting walls 1 spaced apart is mounted a limiting plate 4 consisting of synthetic material, which runs in a line with the steel mounting walls. The steel mounting walls 1 find use primarily in existing lightweight walls 3, which are not sufficient for absorption of the resulting loads. The steel mounting walls 1 may be bolted to the lightweight walls 3. The clearance between lightweight wall 3 and steel mounting wall 1 is sealed with silicone.

As FIG. 3 shows, use of the steel mounting wall 1 according to the invention permits a free arrangement of the farrowing pen, in a passageway for example. For the absorption of tipping moments, there is in addition provided a supporting wall 5, which runs at right angles to the steel mounting wall 1 and advantageously is bolted to the steel mounting wall 1.

According to the invention, four farrowing pens 2 may alternatively be mounted on a steel mounting wall 1. As shown in FIG. 4, on each side of the steel mounting wall 1 are fastened two farrowing pens 2 lying side-by-side, a central supporting wall 5 being assigned to each side of the steel mounting wall 1. The feed trough located in the front region is provided with the reference numeral 10.

A serial arrangement of the farrowing pens results in left and right end farrowing pens, thus allowing for the possibility of providing a mounting plate of half size in each instance and providing the latter with a farrowing pen.

According to the invention, a solid wall is not required for mounting the farrowing pen 2. Mounting is possible within a short time.

### LIST OF REFERENCE NUMERALS

1 steel mounting wall
2 farrowing pen
3 lightweight wall
4 limiting plate
5 supporting wall
6 bores in 1
7 lower offset
8 angular offsets
9 brackets of 2
10 feed trough

1-18. (canceled)

19. A farrowing pen and assigned pigsty combination comprising:
a steel mounting wall comprising a sheet panel construction;
a supporting wall coupled to the steel mounting wall in a substantially perpendicular orientation to form a corner; and
the farrowing pen coupled to both the steel mounting wall and the supporting wall in an angled orientation at the corner to at least partially define a feed trough;
wherein at least one of the steel mounting wall and the supporting wall is coupled to a floor of the pigsty.

20. The farrowing pen and assigned pigsty combination according to claim 19, wherein the steel mounting wall includes a through-bore in the sheet panel, and a fastener extends through the through-bore to couple the steel mounting wall to the farrowing pen.

21. The farrowing pen and assigned pigsty combination according to claim 19, wherein the steel mounting wall has lower rectangular offsets, which are configured to be bolted to the floor of the pigsty.

22. The farrowing pen and assigned pigsty combination according to claim 19, further comprising brackets between the farrrowing pen and the steel mounting wall configured to provide a fastening surface that runs parallel to the steel mounting wall.

23. The farrowing pen and assigned pigsty combination according to claim 19, wherein at least two farrowing pens are fastened to the steel mounting wall.

24. The farrowing pen and assigned pigsty combination according to claim 19, wherein both the steel mounting wall and the supporting wall is coupled to the floor of the pigsty.

25. The farrowing pen and assigned pigsty combination according to claim 19, wherein each of the lateral boundaries of the steel mounting wall have angular offsets, which are configured to be coupled to a limiting plate oriented in a line extending along the steel mounting wall.

26. The farrowing pen and assigned pigsty combination according to claim 19, wherein the steel mounting wall is positioned adjacent to a lightweight insulating wall.

27. The farrowing pen and assigned pigsty combination according to claim 26, wherein the steel mounting wall is coupled to the lightweight insulating wall.

28. A farrowing pen and assigned pigsty combination comprising:
a steel mounting wall comprising a sheet panel construction;
a supporting wall centrally coupled to the steel mounting wall in a substantially perpendicular orientation to form a corner on each side of the supporting wall; and
a farrowing pen coupled to both the steel mounting wall and the supporting wall in an angled orientation at each corner to at least partially define a feed trough;
wherein each of the steel mounting wall and the supporting wall is coupled to a floor of the pigsty.

29. The farrowing pen and assigned pigsty combination according to claim 28, wherein the steel mounting wall includes a through-bore in the sheet panel, and a fastener extends through the through-bore to couple the steel mounting wall to the farrowing pen.

30. The farrowing pen and assigned pigsty combination according to claim 28, wherein each of the lateral boundaries of the steel mounting wall have angular offsets, which are configured to be coupled to a limiting plate oriented in a line extending along the steel mounting wall.

31. The farrowing pen and assigned pigsty combination according to claim 30, wherein the limiting plate is made of synthetic material.

32. The farrowing pen and assigned pigsty combination according to claim 28, wherein a limiting plate is coupled at one lateral boundary of the limiting plate to the steel mounting wall, and the limiting plate is coupled at an opposing lateral boundary to an additional steel mounting wall, wherein the steel mounting wall, the limiting plate and the additional steel mounting wall are orienting in a line.

33. The farrowing pen and assigned pigsty combination according to claim 32, wherein an additional supporting wall is coupled to the additional steel mounting wall in an substantially perpendicular orientation to form an additional corner; and
an additional farrowing pen coupled to both the additional steel mounting wall and the additional supporting wall in an angled orientation at the additional corner to at least partially define a feed trough;
wherein both of the additional steel mounting wall and the additional supporting wall is coupled to a floor of the pigsty.

34. The farrowing pen and assigned pigsty combination according to claim 28, wherein two farrowing pens are fastened to each side of the steel mounting wall.

35. The farrowing pen and assigned pigsty combination according to claim 28, wherein the steel mounting wall is positioned adjacent to a lightweight insulating wall.

36. The farrowing pen and assigned pigsty combination according to claim 35, wherein the steel mounting wall is coupled to the lightweight insulating wall.
